(19) United States
(12) Patent Application Publication
(10) Pub. No.: US 2026/0059214 A1
(43) Pub. Date: Feb. 26, 2026

(54) SOUND-GENERATING DEVICE AND ELECTRONIC TERMINAL

(71) Applicant: AAC Microtech (Changzhou) Co., Ltd., Changzhou City (CN)

(72) Inventors: Wu Wang, Changzhou (CN); Ke Li, Changzhou (CN); Guangkun Chen, Changzhou (CN)

(21) Appl. No.: 18/979,696

(22) Filed: Dec. 13, 2024

Related U.S. Application Data
(63) Continuation of application No. PCT/CN2024/113343, filed on Aug. 20, 2024.

(51) Int. Cl. H04R 1/02; G06F 1/16; H04R 1/06

(52) U.S. Cl. CPC H04R 1/025; G06F 1/1658; H04R 1/026; H04R 1/06; H04R 2499/11

(57) ABSTRACT

Provided are a sound-generating device and an electronic terminal. The sound-generating device includes an annular housing, a lower cover fixed to a side of the housing, an upper cover extending inward from the other side of the housing and enclosing to form a sound-generating hole, and a sound-generating unit supported on and fixed to a side of the upper cover close to the lower cover and located in the housing. The sound-generating unit, the housing, and the lower cover jointly enclose a rear cavity, and a sound-generating side of the sound-generating unit directly faces the sound-generating hole. The sound-generating device further comprises an annular first silicone rubber member injection-molded into the housing, the first silicone rubber member seals and surrounds a peripheral side of the sound-generating unit, and the first silicone rubber member abuts against inner sides of both the upper cover and the housing to seal the rear cavity.

### TECHNICAL FIELD

The present disclosure relates to the technical field of electroacoustic conversion, and in particular to a sound-generating device and an electronic terminal.

### BACKGROUND

With the advent of the mobile internet era, the number of smart mobile devices continues to rise. Among numerous mobile devices, mobile phones are undoubtedly the most common and most portable mobile terminal devices. At present, mobile phones have extremely diverse functions, one of which is a high-quality music function. Therefore, sound-generating devices for playing sound are widely applied in today’s smart mobile devices.

A commonly used sound-generating device includes a housing, an upper cover and a lower cover fixed on two sides of the housing, and a sound-generating unit fixed in the housing. The sound-generating unit is fixedly connected to the housing with plastic. An outer side of the housing is fixedly connected to the upper cover through foam. However, by fixedly connecting the sound-generating unit and the housing with plastic, a rear cavity formed by the sound-generating unit and the lower cover is reduced, resulting in poor acoustic performance. Additionally, by fixedly connecting the upper cover and the housing with foam, the sealing performance is poor, resulting in poor water resistance.

Therefore, it is necessary to provide a new sound-generating device to solve the above-mentioned technical problems.

### SUMMARY

An object of the present disclosure is to provide a sound-generating device with good waterproof sealing performance and better overall acoustic performance.

In order to achieve the above object, the present disclosure provides a sound-generating device, including an annular housing, a lower cover fixed to a side of the housing, an upper cover extending inward from the other side of the housing and enclosing to form a sound-generating hole, and a sound-generating unit supported on and fixed to a side of the upper cover close to the lower cover and located in the housing, where the sound-generating unit, the housing, and the lower cover jointly enclose a rear cavity, and a sound-generating side of the sound-generating unit directly faces the sound-generating hole; and where the sound-generating device further includes an annular first silicone rubber member injection-molded into the housing, the first silicone rubber member seals and surrounds a peripheral side of the sound-generating unit, and the first silicone rubber member abuts against inner sides of both the upper cover and the housing to seal the rear cavity.

As an improvement, the housing is of a rectangular structure, and the first silicone rubber member is of a rectangular structure.

As an improvement, the housing is made of metal material.

As an improvement, the sound-generating device further includes a seal plate, the lower cover is penetrated to form a through hole communicating with the rear cavity, and the seal plate is fixed to a side of the lower cover away from the sound-generating unit and covers the through hole.

In a second aspect, an embodiment of the present disclosure provides an electronic terminal, including a shell, a supporting wall protruding from and formed inside the shell, and the above- described sound-generating device supported on the supporting wall, where the sound-generating side of the sound-generating device is spaced apart from the shell to form a front cavity; and where the sound-generating device further includes an annular second silicone rubber member injection-molded on a side of the upper cover away from the lower cover, the second silicone rubber member includes an annular silicone rubber body fixed on a side of the upper cover close to the lower cover and a bending portion bent and extending inwardly from the silicone rubber body towards the shell, and the bending portion abuts against the shell to form a seal.

As an improvement, the first silicone rubber member and the second silicone rubber member are integrally injection-molded.

As an improvement, the sound-generating device further includes a flexible conductive member, one end of the flexible conductive member is configured to be connected to an external power supply, and the other end of the flexible conductive member penetrates through a side of the housing and is electrically connected to the sound-generating unit.

As an improvement, the flexible conductive member includes a conductive body fixed to the shell, a positive terminal and a negative terminal which are formed at an end of the conductive body, and the other end of the conductive body is connected to the sound-generating unit.

Compared with the related art, in the sound-generating device of the present disclosure: the annular first silicone rubber member is injection-molded into the housing, the first silicone rubber member seals and surrounds the peripheral side of the sound-generating unit, and abuts against the inner sides of both the upper cover and the housing to seal the rear cavity; the first silicone rubber member seals and surrounds the sound-generating unit and is configured to position the sound-generating unit in the housing and for waterproof sealing the front and rear cavities; and meanwhile, the first silicone rubber member surrounds the sound-generating unit, so that the overall position of the sound unit is moved downwards, thereby enlarging the rear cavity and improving the acoustic performance of the sound-generating device.

### BRIEF DESCRIPTION OF DRAWINGS

In order to illustrate the technical solutions in the embodiments of the present disclosure more clearly, the accompanying drawings required to be used in the description of the embodiments will be described briefly below. It is apparent that the accompanying drawings in the following description are merely some embodiments of the present disclosure, and for those of ordinary skill in the art, other accompanying drawings can be obtained based on these accompanying drawings without creative effort.

FIG. 1 is a schematic view of a three-dimensional structure of a sound-generating device provided by an embodiment of the present disclosure;

FIG. 2 is an exploded view of the three-dimensional structure of the sound-generating device provided by the embodiment of the present disclosure;

FIG. 3 is a cross-sectional view taken along a line A-A in FIG. 1;

FIG. 4 is a schematic view of a three-dimensional structure of an electronic terminal provided by an embodiment of the present disclosure;

FIG. 5 is an exploded view of the three-dimensional structure of the electronic terminal provided by the embodiment of the present disclosure; and

FIG. 6 is a cross-sectional view taken along line B-B of FIG. 4.

In the drawings, 100-sound-generating device, 1-housing, 101-sound-generating hole, 2-lower cover, 3-upper cover, 4-sound-generating unit, 5-first silicone rubber member, 6-second silicone rubber member, 61-silicone rubber body, 62-bending portion, 7-front cavity, 8-rear cavity, 9-through hole, 10-seal plate, 11-flexible conductive member, 111-conductive body, 112-positive terminal, 113-negative terminal, 200-electronic terminal, 201-shell, 202-supporting wall.

### DESCRIPTION OF EMBODIMENTS

The technical solutions in embodiments of the present disclosure will be described clearly and fully below in conjunction with the drawings in the embodiments of the present disclosure. It is apparent that the described embodiments are only some rather than all of the embodiments of the present disclosure. Based on the embodiments in the present disclosure, all other embodiments obtained by those of ordinary skill in the art without any creative effort fall within the protection scope of the present disclosure.

### Embodiment I

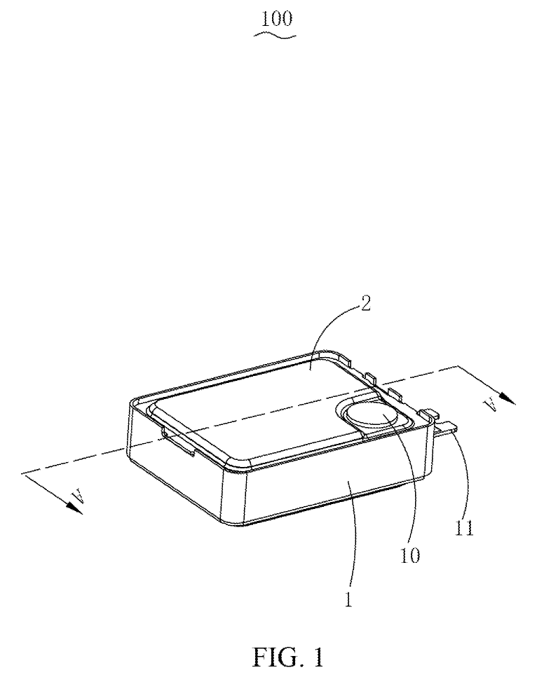

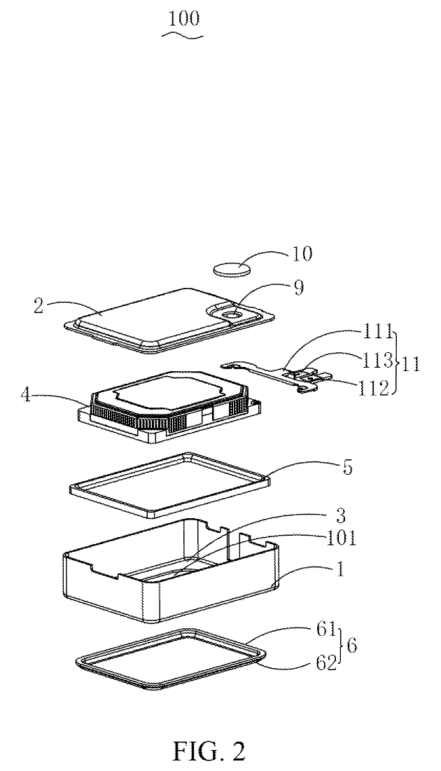

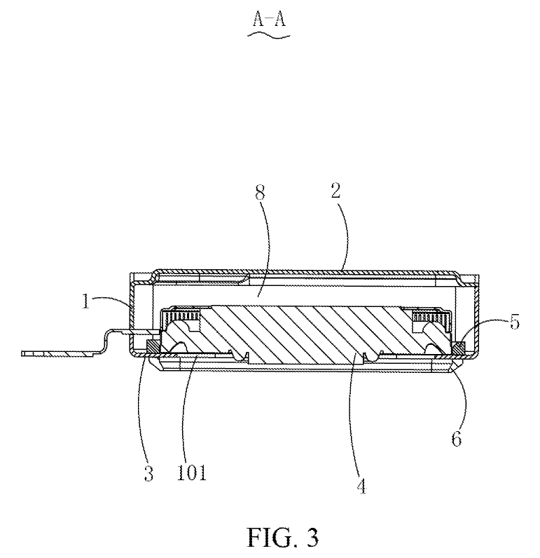

As shown in conjunction with FIG. 1 to FIG. 3, an embodiment of the present disclosure provides a sound-generating device 100, including an annular housing 1, a lower cover 2 fixed to a side of the housing 1, an upper cover 3 extending inward from the other side of the housing 1 and enclosing to form a sound-generating hole 101, and a sound-generating unit 4 supported on and fixed to a side of the upper cover 3 close to the lower cover 2 and located in the housing 1. The sound-generating unit 4, the housing 1, and the lower cover 2 jointly enclose a rear cavity 8, and a sound-generating side of the sound-generating unit 4 directly faces the sound-generating hole 101. The sound-generating device 100 further includes an annular first silicone rubber member 5 injection-molded into the housing 1. The first silicone rubber member 5 seals and surrounds a peripheral side of the sound-generating unit 4, and abuts against inner sides of both the upper cover 3 and the housing 1 to seal the rear cavity 8.

The housing 1 is configured to support and fix the upper cover 3, the lower cover 2, and the sound-generating unit 4. The rear cavity 8 is formed by the housing 1 together with the sound-generating unit 4 and the lower cover 2, the first silicone rubber member 5 seals and surrounds the sound-generating unit 4 and is configured to position the sound-generating unit 4 in the housing 1 and for waterproof sealing front and rear cavities, and at the same time the first silicone rubber member 5 surrounds the sound-generating unit 4, so that the overall position of the sound emitting unit 4 is moved downwards, thereby enlarging the rear cavity 8 and improving the acoustic performance of the sound-generating device 100.

In particular, the first silicone rubber member 5 is injection-molded on the housing 1 by cleaning the housing 1, brushing a bonding agent on an inner surface of the housing 1, forming the first silicone rubber member 5 on the inner side of the housing 1 through a LSR injection, performing deflashing and degating on the first silicone rubber member 5, and finally performing inspection and package. Where the LSR (Liquid Silicone Rubber) is called liquid silicone rubber, which is made of silicone rubber goods and has good elasticity, waterproof and moisture-proof properties, as well as resistance to corrosion caused by various chemical substances such as acid and alkali.

In this embodiment, the housing 1 is of a rectangular structure, and the first silicone rubber member 5 is provided as a rectangular structure. The rectangular structure is convenient for injection-molding, stable in structural strength and easy to assembly.

In this embodiment, the housing 1 is made of metal material. The metal material has high structural strength and good supporting performance.

In this embodiment, the sound-generating device 100 further includes a seal plate 10. The lower cover 2 is penetrated to form a through hole 9 communicating with the rear cavity. The seal plate 10 is fixed to a side of the lower cover 2 away from the sound-generating unit 4 and covers the through hole 9. This further improves the sealing performance of the lower cover 2.

Compared with the related art, in the sound-generating device of the present disclosure: the annular first silicone rubber member is injection-molded into the housing, the first silicone rubber member seals and surrounds the peripheral side of the sound-generating unit, and abuts against the inner sides of both the upper cover and the housing to seal the rear cavity; the first silicone rubber member seals and surrounds the sound-generating unit and is configured to position the sound-generating unit in the housing and for waterproof sealing the front and rear cavities; and meanwhile, the first silicone rubber member surrounds the sound-generating unit, so that the overall position of the sound unit is moved downwards, thereby enlarging the rear cavity and improving the acoustic performance of the sound-generating device.

### Embodiment II

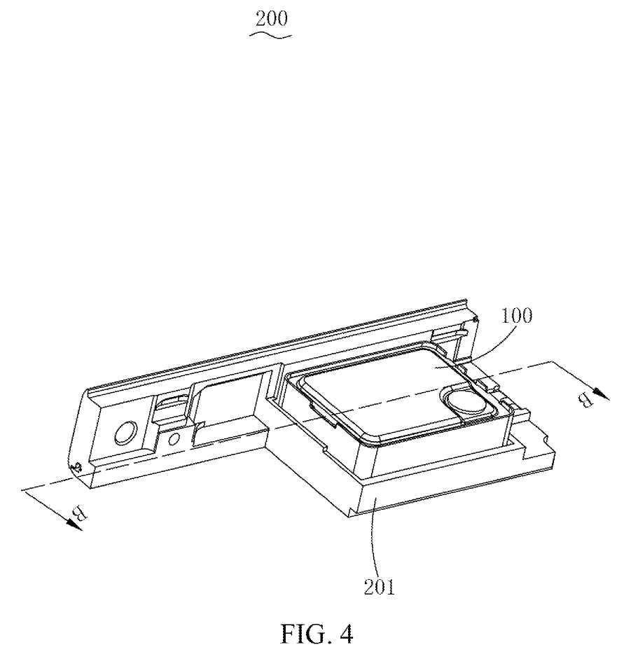

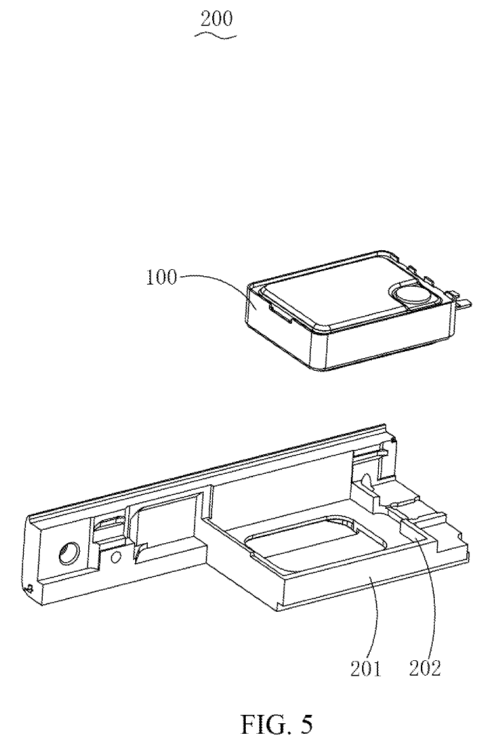

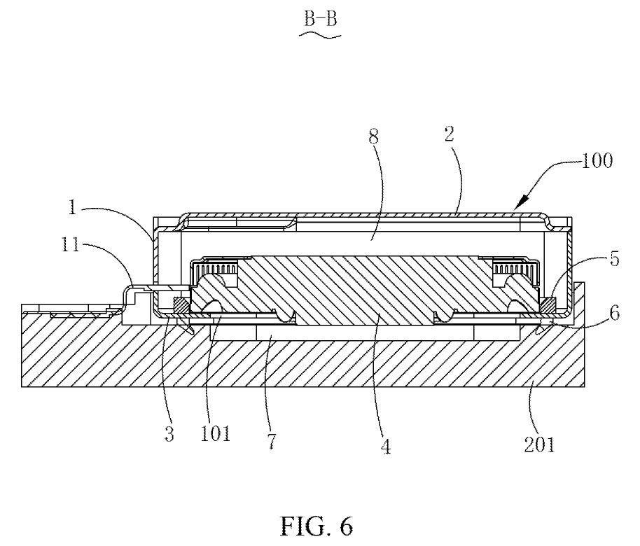

As shown in conjunction with FIG. 1 to FIG. 6, an embodiment of the present disclosure provides an electronic terminal 200, including a shell 201, a supporting wall 202 protruding from and formed inside the shell 201, and the above-mentioned sound-generating device 100 supported on the supporting wall 202. The sound-generating side of the sound-generating device 100 is spaced apart from the shell 201 to form the front cavity 7. The sound-generating device 100 further includes an annular second silicone rubber member 6 injection-molded on a side of the upper cover 3 away from the lower cover 2. The second silicone rubber member 6 includes an annular silicone rubber body 61 fixed on a side of the upper cover 3 close to the lower cover 2 and a bending portion 62 bent and extending inwardly from the silicone rubber body 61 towards the shell 201, and the bending portion 62 abuts against the shell 201 to form a seal, so that the performance of the waterproof sealing between the shell 201 and the sound-generating device 100 is good.

In this embodiment, the first silicone rubber member 5 and the second silicone rubber member 6 are integrally injection-molded. The structure has high strength, and the integrally injection-molding is convenient for production.

In this embodiment, the sound-generating device 100 further includes a flexible conductive member 11. One end of the flexible conductive member 11 is configured to be connected to an external power supply, and the other end of the flexible conductive member 11 penetrates through a side of the housing 1 and is electrically connected to the sound-generating unit 4, which facilitates the external power supply to conduct electricity for the sound-generating unit 4, thereby causing the sound-generating unit 4 to vibrate to generate sound and the acoustic performance of the sound-generating device 100 to be excellent. Optional, the external power supply may be a battery or a power supply.

In this embodiment, the flexible conductive member 11 includes a conductive body 111 fixed to the shell 201, a positive terminal 112 and a negative terminal 113 which are formed at an end of the conductive body 111, and the other end of the conductive body 111 is connected to the sound-generating unit 4.

In particular, the first silicone rubber member is injection-molded on the housing 1 by cleaning the housing 1, brushing a bonding agent on an outer surface of the housing 1, forming the second silicone rubber member 6 on the outer side of the housing 1 through a LSR injection, performing deflashing and degating on the second silicone rubber member 6, and finally performing inspection and package.

The above description merely illustrates the embodiments of the present disclosure. Here, it should be noted that improvements can be made by those of ordinary skill in the art without departing from the inventive concept of the present disclosure, and all of the improvements shall fall into the protection scope of the present disclosure.

What is claimed is:

1. A sound-generating device, comprising:
an annular housing,
a lower cover fixed to a side of the housing,
an upper cover extending inward from the other side of the housing and enclosing to form a sound-generating hole, and
a sound-generating unit supported on and fixed to a side of the upper cover close to the lower cover and located in the housing,
wherein the sound-generating unit, the housing, and the lower cover jointly enclose a rear cavity, and a sound-generating side of the sound-generating unit directly faces the sound-generating hole; and
wherein the sound-generating device further comprises an annular first silicone rubber member injection-molded into the housing, the first silicone rubber member seals and surrounds a peripheral side of the sound-generating unit, and the first silicone rubber member abuts against inner sides of both the upper cover and the housing to seal the rear cavity.

2. The sound-generating device as described in claim 1, wherein the housing is of a rectangular structure, and the first silicone rubber member is of a rectangular structure.

3. The sound-generating device as described in claim 1, wherein the housing is made of metal material.

4. The sound-generating device as described in claim 1, further comprising a seal plate, wherein the lower cover is penetrated to form a through hole communicating with the rear cavity, and the seal plate is fixed to a side of the lower cover away from the sound-generating unit and covers the through hole.

5. An electronic terminal, comprising:
a shell,
a supporting wall protruding from and formed inside the shell, and
a sound-generating device as described in claim 1 supported on the supporting wall,
wherein the sound-generating side of the sound-generating device is spaced apart from the shell to form a front cavity; and
wherein the sound-generating device further comprises an annular second silicone rubber member injection-molded on a side of the upper cover away from the lower cover, the second silicone rubber member comprises an annular silicone rubber body fixed on a side of the upper cover close to the lower cover and a bending portion bent and extending inwardly from the silicone rubber body towards the shell, and the bending portion abuts against the shell to form a seal.

6. The electronic terminal as described in claim 5, wherein the first silicone rubber member and the second silicone rubber member are integrally injection-molded.

7. The electronic terminal as described in claim 5, wherein the sound-generating device further comprises a flexible conductive member, wherein one end of the flexible conductive member is configured to be connected to an external power supply, and the other end of the flexible conductive member penetrates through a side of the housing and is electrically connected to the sound-generating unit.

8. The electronic terminal as described in claim 7, wherein the flexible conductive member comprises a conductive body fixed to the shell, a positive terminal and a negative terminal which are formed at an end of the conductive body, and the other end of the conductive body is connected to the sound-generating unit.
